(19) United States
(12) Patent Application Publication
(10) Pub. No.: US 2012/0259964 A1
(43) Pub. Date: Oct. 11, 2012

(54) Cloud computing method capable of hiding real file paths

(75) Inventors: Chih-Chiang Lin, Taipei City (TW); Hung-Chun Kao, Taipei City (TW); Yu-Sheng Lin, Taipei City (TW); Ting-Yu Chiang, Taipei City (TW); Shih-Hui Wu, Taipei City (TW); Wen-Yuan Wang, Taipei City (TW); Cho-Hsuan Lee, Taipei City (TW); Chi-Ming Luo, Taipei City (TW); Yi-Hua Liang, Taipei City (TW); Min-Hui Wu, Taipei City (TW); Hsiao-Yun Chen, Taipei City (TW); Kuan-Yi Chang, Taipei City (TW); Chi-Hsiu Huang, Taipei City (TW); Jia-Bin Lai, Taipei City (TW); Heng-Chang Lin, Taipei City (TW); Yu-Hsiang Wang, Taipei City (TW)

(73) Assignee: D-Link Corporation, Taipei City (TW)

(21) Appl. No.: 13/137,527

(22) Filed: Aug. 24, 2011

(30) Foreign Application Priority Data
Apr. 11, 2011 (TW) 100112396

(51) Int. Cl. G06F 15/173

(52) U.S. Cl. 709/223

(57) ABSTRACT

The present invention is to provide a cloud computing method capable of hiding real file paths, which includes the steps of: triggering a web browsing button of an application program and sending a browsing activation signal to a management server by a terminal device; reading a directory list of at least one file from a file server and sending a file browsing program and the directory list to the terminal device by the management server; displaying the directory list via the file browsing program and sending a file processing signal to the management server by the terminal device; downloading from the file server a file specified by the file processing signal and sending the specified file to the terminal device by the management server; and sending the specified file to a third-party application server via the application program and terminating the file browsing program by the terminal device.

### FIELD OF THE INVENTION

The present invention relates to a file processing method executed by a third-party application through a cloud computing, more particularly to a cloud computing method capable of hiding real file paths of files being processed, so as to effectively prevent those who have ill intentions from knowing the real file paths of the files being processed via the third-party application and attacking a server for storing the files accordingly.

### BACKGROUND OF THE INVENTION

Recently, as cloud computing services and applications gradually mature, the way people use computers has changed. The International Data Corporation (IDC) estimated that the average growth rate of cloud services in the next five years will be as high as 26%. Therefore, in order to take advantage of such huge business opportunities, many companies have set foot in cloud computing.

Cloud computing is implemented via an Internet-based shared IT framework in which “cloud” refers to computers that are located on the Internet and have high computing capabilities. In cloud computing, a user end is connected via the Internet to a virtual server composed of a plurality of computers, so that the computers can be used to process all kinds of IT-related work and send the processing results to the user end. More specifically, cloud computing is an application of distributed computing. A task to be done is typically divided into several smaller parts that are sent respectively to a number of computers for computation and integration to produce the final result. Hence, with cloud computing, one can complete a vast amount of IT-related work within a few seconds as if by using a “super computer”. In addition, cloud computing relies on “virtual” resources and is therefore not subject to hardware or software limitations at the local or remote end. Anyone applying the cloud computing technique can share the hardware and software resources and information of a super computer without having to purchase the expensive hardware or software being used.

Nowadays, people only have to use a web browser to access cloud computing services (e.g., search engines, electronic mail services, web photo albums, and on-line application programs) provided by network service providers; in other words, there is no need for the users to install professional software or upgrade the existing hardware. For instance, referring to FIG. 1, a network system 1 includes a terminal device 11, a third-party application server 13, and a file server 15, wherein both the terminal device 11 and the file server 15 are located in a local network. The terminal device 11, which can be a desktop computer, a laptop computer, a tablet computer, or the like, is built-in with a web browser 111 (e.g., Chrome, Firefox, Internet Explore, and so on). The third-party application server 13 is built-in with an image editing program 131. The file server 15 stores a plurality of picture files 151 and can generate a directory list 153 according to the picture files 151. If a user wishes to make a card and provide the card with a picture having special graphic effects, the user can use the terminal device 11 to connect with the third-party application server 13. Once the connection is established, the third-party application server 13 sends an application program 113 to the terminal device 11, wherein the application program 113 is a pop-out window or can call the file manager of the terminal device 11 (see FIG. 2), so as for the user to select a picture from within the terminal device 11, or a picture file 151 from the file server 15, using the application program 113.

Referring to FIGS. 1 and 2, when it is desired to use the picture files 151 in the file server 15, it is common practice for the user to operate the terminal device 11 by first selecting the item “Network neighbors” displayed by the application program 113 and then clicking on the icon representing the file server 15. As a result, the terminal device 11 is connected to the file server 15 and receives therefrom the directory list 153. The user can now directly view all the picture files 151 in the file server 15 and select one of the picture files 151 by operating the terminal device 11. Once the desired picture file 151 is selected, the terminal device 11 sends a picture file selection signal to the third-party application server 13, which, upon reading the signal, requests the selected picture file 151 from the file server 15. In response, the file server 15 sends a Uniform Resource Locator (URL) and a token to the third-party application server 13, thus allowing the third-party application server 13 to download the selected picture file 151 from the file server 15 and then process the selected picture file 151 with the image editing program 131. After completing the image processing operation on the selected picture file 151, the third-party application server 13 sends the processed picture file 151 to the terminal device 11. Thus, the user can provide the selected picture file 151 with special graphic effects without having to install the professional image editing program 131 or upgrade the terminal device 11 in terms of hardware specifications. It is also feasible to store the processed picture file 151 into the file server 15 so that the user can download the processed picture file 151 through the Internet at any time.

While cloud computing services provide tremendous convenience, they have certain underlying concerns, the most important of which is network security. This is because not necessarily all the data stored on the Internet by a particular user are intended to be viewed or used by others. In cloud computing, however, these data are controlled by a third party. Take the case described above for example. Referring to FIG. 1, although all the picture files 151 for use by the user are stored in the file server 15, the third-party application server 13 will be given a URL by the file server 15 before downloading any picture file 151. Therefore, a person with ill intentions can locate the file server 15 through the third-party application server 13 and, after invading the file server 15 by illegal means, steal the private data stored in the file server 15.

According to the above, existing cloud computing services—especially those relying on third-party applications—have security issues and are vulnerable to data theft. Hence, it is of great importance for network service providers and the related companies to design a novel cloud computing method that provides enhanced security for users' private data.

### BRIEF SUMMARY OF THE INVENTION

In view of the security problems of existing cloud computing methods, the inventor of the present invention conducted extensive research and experiments and finally succeeded in developing a cloud computing method capable of hiding real file paths as disclosed herein. The disclosed cloud computing method is intended to hide the source location of files, minimize the risks of exposure of the location where the files are stored, and thereby significantly increase the security of users' private data.

It is an object of the present invention to provide a cloud computing method capable of hiding real file paths, wherein the method is applicable to a network system that includes a terminal device, a file server, a management server, and a third-party application server. The management server is connected respectively to the terminal device and the file server. The third-party application server is connected to the terminal device. The terminal device is installed with an application program which, once executed by the terminal device, displays a web browsing button and a save button on the terminal device. The file server stores at least one file and can generate a directory list according to the at least one file. To read files, the cloud computing method is carried out as follows. The terminal device sends a browsing activation signal to the management server when the web browsing button is triggered. Upon receiving the browsing activation signal, the management server reads the directory list from the file server and sends a file browsing program to the terminal device along with the directory list. The terminal device displays the directory list via the file browsing program and, upon receiving a file selection command, selects at least one file from the directory list according to the file selection command. Then, the terminal device sends a file processing signal to the management server, so as for the management server to download from the file server the file specified by the file processing signal and send the specified file to the terminal device. Finally, the terminal device sends the specified file to the third-party application server through the application program, thus allowing the third-party application server to process the specified file. Meanwhile, the file browsing program is terminated by the terminal device. In the foregoing process, the file received by the third-party application server comes from the terminal device, and the third-party application server makes no connection to the file server. This prevents those with ill intentions from knowing the location of the file server via the third-party application server or via data related to the file received by the third-party application server. Consequently, the risks of cyber attack are reduced, the security of the file server is effectively enhanced.

It is another object of the present invention to provide the foregoing cloud computing method, wherein in order to save files, the method is carried out in the following manner. The terminal device receives the processed file from the third-party application server and triggers the save button. As a result, the file browsing program is activated, and the directory list is displayed via the file browsing program. Upon receiving a save command, the terminal device selects a saving path from the directory list according to the save command and sends a file saving path signal to the management server along with the processed file. Upon receiving the file saving path signal and the processed file, the management server sends the processed file to a location in the file server that corresponds to the saving path contained in the file saving path signal. In short, to store the processed file, the processed file is downloaded from the third-party application server to the terminal device and then sent from the terminal device to the management server and finally to the file server. By doing so, the third-party application server is also prevented from making any connection with the file server, with a view to effectively hiding the real location of the file server and keeping the private data in the file server safe from theft.

Yet another object of the present invention is to provide the foregoing cloud computing method, wherein the management server, after downloading the specified file, performs format conversion on the specified file. More specifically, the management server converts a binary file into a Data URI file and sends the Data URI file to the terminal device, which in turn sends the Data URI file to the third-party application server. The third-party application server then converts the Data URI file into a binary file and processes the binary file. The Data URI format not only can speed up file transfer but also allows files to be transferred between servers using different operating systems and be directly displayed on web browsers (e.g., Chrome, Firefox, Internet Explorer, and so on) by means of a dynamic scripting language (e.g., JavaScript or JScript), thus substantially facilitating file transfer.

### BRIEF DESCRIPTION OF THE SEVERAL VIEWS OF THE DRAWINGS

A detailed description of further features and advantages of the present invention is given below with reference to the accompanying drawings, in which:

FIG. 1 is a schematic drawing of a network system for performing cloud computing in a conventional manner;

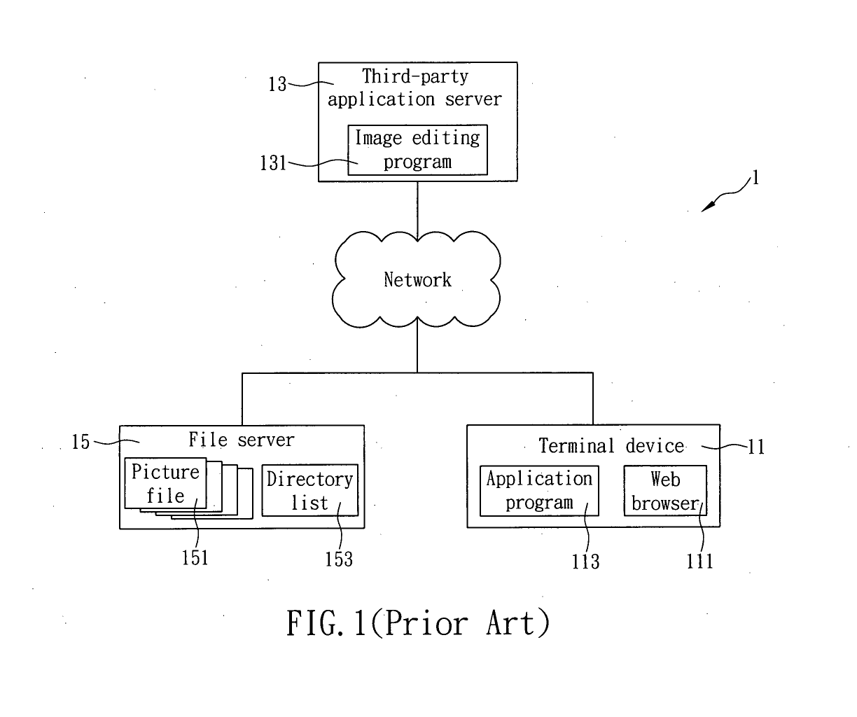

FIG. 2 schematically shows an application program in the network system depicted in FIG. 1;

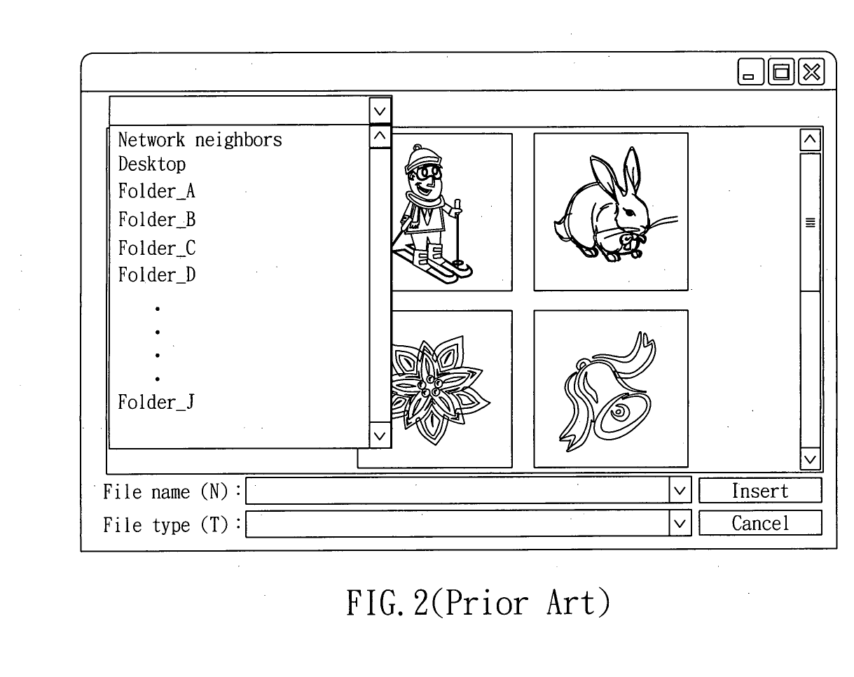

FIG. 3 is a schematic drawing of a network system according to an embodiment of the present invention;

FIG. 4 schematically shows an application program of the present invention after it is activated;

FIG. 5 is a sequence diagram for reading a file according to the present invention;

FIG. 6 schematically shows a file browsing program of the present invention displaying a directory list;

FIG. 7 schematically shows the file browsing program of the present invention displaying a file;

FIG. 8 schematically shows the file browsing program of the present invention displaying a processed file;

FIG. 9 is a sequence diagram for storing a file according to the present invention; and

FIG. 10 is a schematic drawing of a network system according to another embodiment of the present invention.

### DETAILED DESCRIPTION OF THE INVENTION

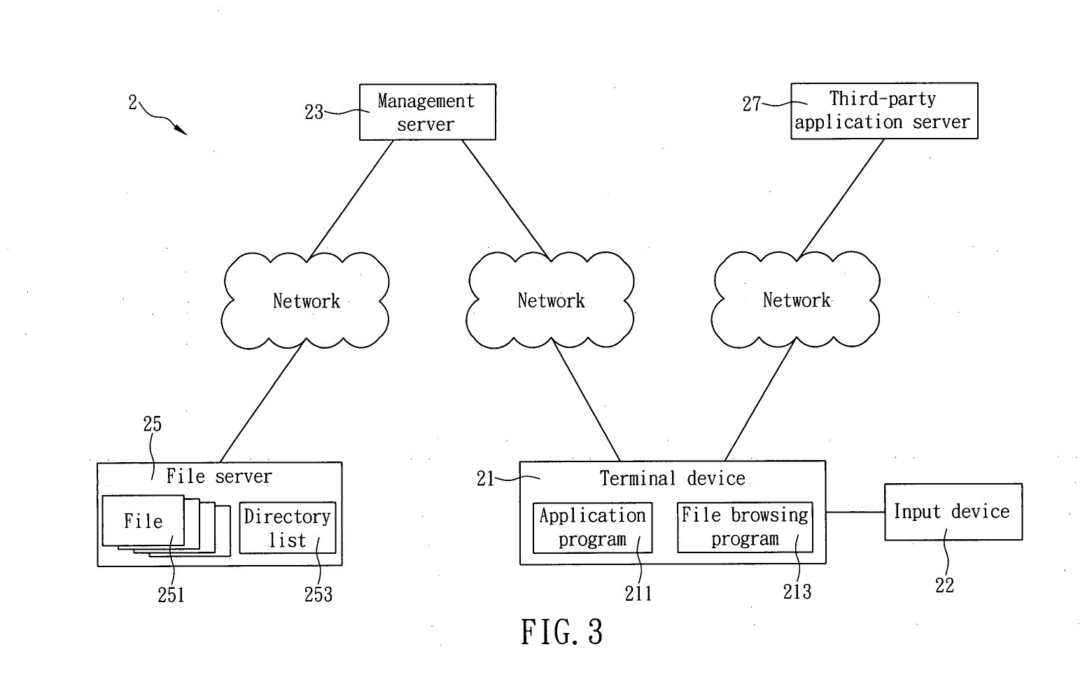

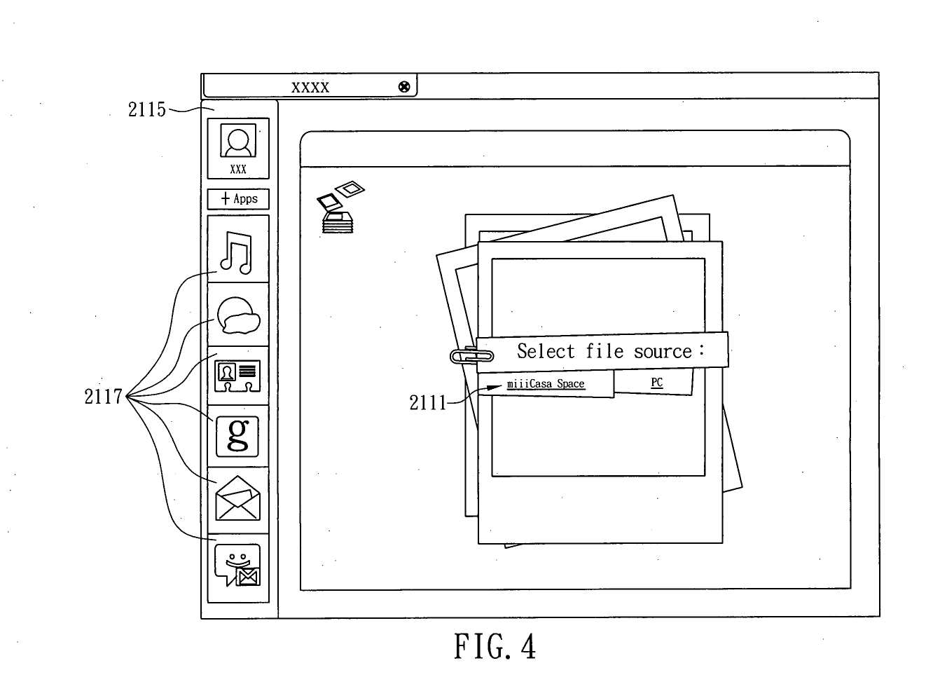

The present invention provides a cloud computing method capable of hiding real file paths. In a preferred embodiment of the present invention, the cloud computing method is applied to a network system 2 as shown in FIG. 3. The network system 2 includes a terminal device 21, a management server 23, a file server 25, and a third-party application server 27. The management server 23 is connected to the terminal device 21 and the file server 25 respectively. The third-party application server 27 is connected to the terminal device 21. The terminal device 21 is installed with an application program 211. The application program 211 can be installed by the user in advance or be downloaded from the third-party application server 27 when it is desired to use the services provided by the third-party application server 27. Once executed by the terminal device 21, the application program 211 displays a web browsing button 2111 (e.g., the “miiiCasa Space” button in FIG. 4) on the terminal device 21. The file server 25 stores at least one file 251 and is configured to generate a directory list 253 according to the at least one file 251. The content of the directory list 253 will be updated according to the number and name(s) of the existing file(s) 251.

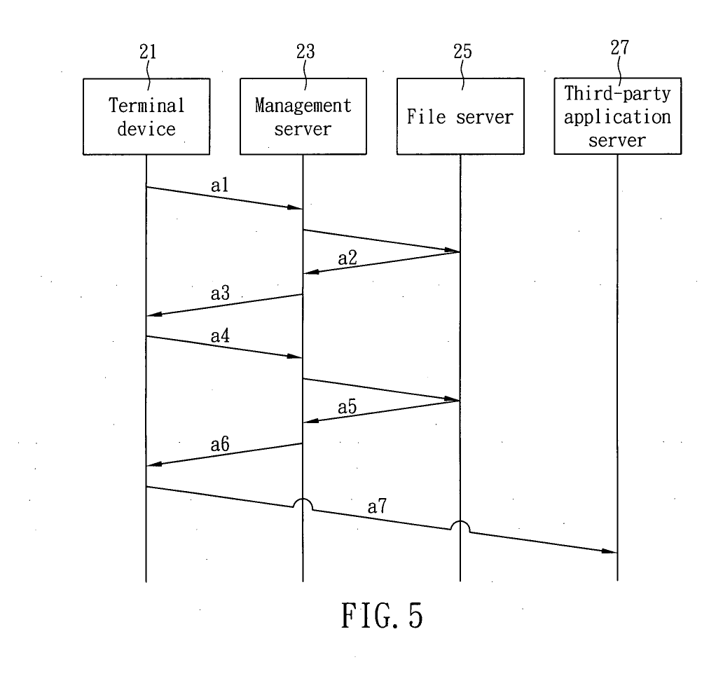

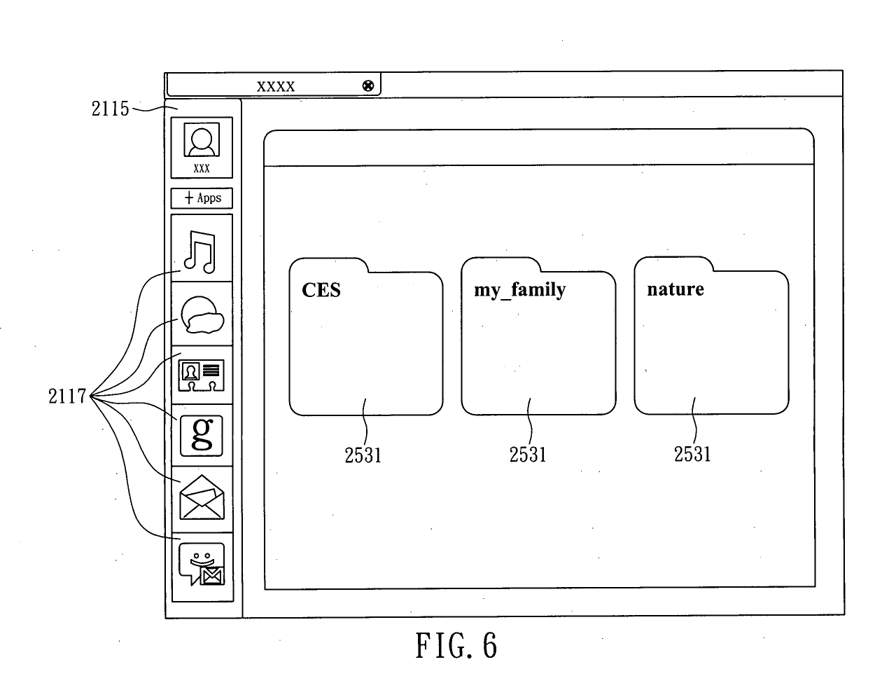

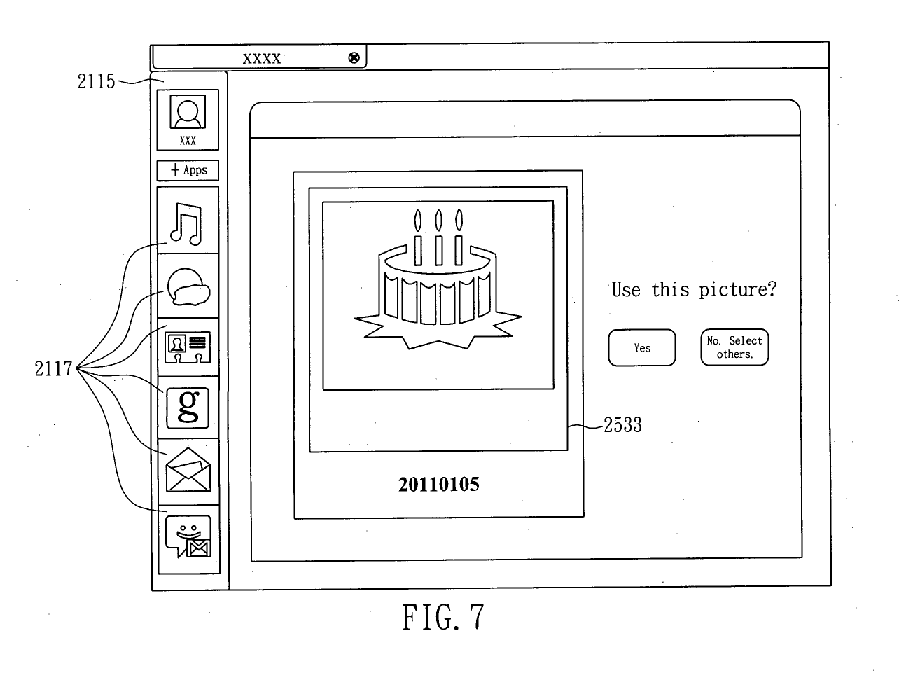

Referring to FIGS. 3 and 4, when it is desired to use the services provided by the third-party application server 27, such as an image editing service, the user can proceed by first activating the application program 211 and then selecting the picture to be edited. If the picture to be edited is within the at least one file 251 stored in the file server 25, the user can use an input device 22 (e.g., a mouse, a keyboard, and so on) to click on the web browsing button 2111 of the application program 211, wherein the input device 22 sends a first trigger command to the terminal device 21 to trigger the web browsing button 2111. Then, referring to FIG. 5, the terminal device 21 sends a browsing activation signal to the management server 23 (a1 in FIG. 5). Upon receipt of the browsing activation signal, the management server 23 reads the directory list 253 from the file server 25 (a2 in FIG. 5) and sends a file browsing program 213 and the directory list 253 to the terminal device 21 (a3 in FIG. 5). The terminal device 21 receives the file browsing program 213 and the directory list 253 and displays the directory list 253 by means of the file browsing program 213. In this embodiment, the directory list 253 includes three folders 2531 (see FIG. 6), namely CES, my_family, and nature. When the user clicks on the my_family folder 2531 via the input device 22, the directory list 253 shows the file(s) 251 in the my_family folder 2531 (e.g., the picture 2533 shown in FIG. 7, with the file name “20110105”). In other embodiments of the present invention, however, the number of the folders 2531 and of the file(s) 251 therein may vary as needed, or there can be files 251 but no folders 2531.

Referring back to FIGS. 3 and 5, once the user uses the input device 22 to click on the desired file 251, the terminal device 21 receives a file selection command from the input device 22, selects the file 251 from the directory list 253 according to the file selection command, and sends a file processing signal to the management server 23 (a4 in FIG. 5). The management server 23 receives and reads the file processing signal to know which file 251 has been selected. Then, the management server 23 downloads from the file server 25 the file 251 specified by the file processing signal (a5 in FIG. 5). In this embodiment, the specified file 251 is the file 251 located in the my_family folder 2531 (see FIG. 6) and having the file name “20110105” (see FIG. 7). Afterward, the management server 23 sends the specified file 251 to the terminal device 21 (a6 in FIG. 5). Upon receipt of the specified file 251, the terminal device 21 sends the specified file 251 to the third-party application server 27 via the application program 211 (a7 in FIG. 5), so as for the third-party application server 27 to process the specified file 251 (e.g., to adjust the image brightness of the file 251, add a special graphic effect to the file 251, and so on). Meanwhile, the terminal device 21 terminates the file browsing program 213. In the process described above, the third-party application server 27 obtains the specified file 251 from the terminal device 21 rather than the file server 25 and makes no connection with the file server 25. This prevents people with evil intentions from knowing the location of the file server 25 either through the third-party application server 27 or from data related to the file 251 received by the third-party application server 27. Consequently, the file server 25 is protected from malicious attack, and the security of the file server 25 is effectively enhanced.

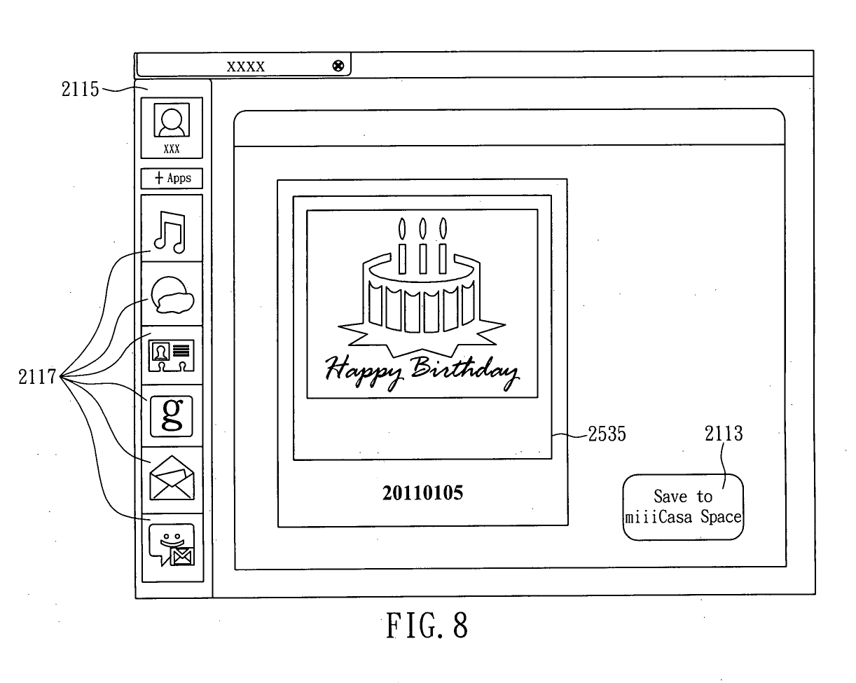

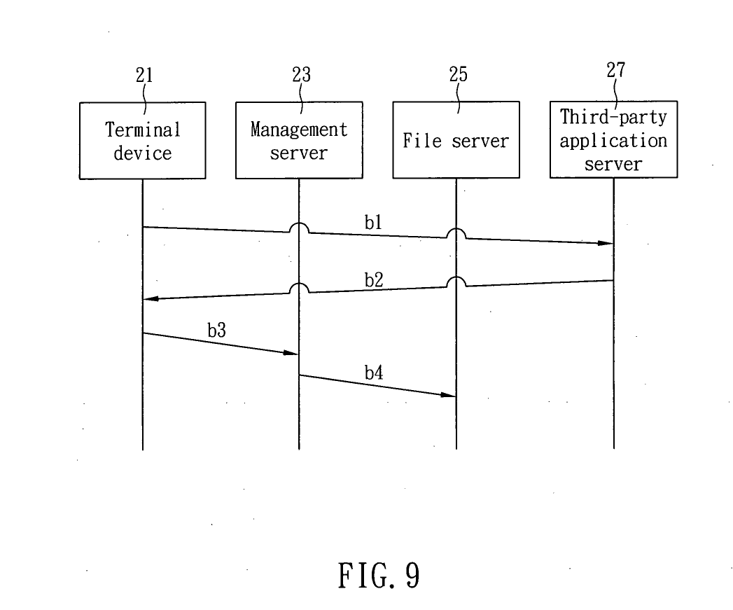

With reference to FIGS. 3 and 8, when the third-party application server 27 has completed processing the file 251, the processed file 251 is displayed by the application program 211 for view by the user (e.g., the picture 2535 shown in FIG. 8) and can be stored into the file server 25 if so desired. To this end, the application program 211 further displays a save button 2113 (e.g., the “Save to miiiCasa Space” button in FIG. 8) on the terminal device 21. The user can use the input device 22 to click on the save button 2113 so that the input device 22 sends out a second trigger command to trigger the save button 2113. Referring to FIG. 9, the terminal device 21 sends a file saving signal to the third-party application server 27 (b1 in FIG. 9), instructing the third-party application server 27 to send the processed file 251 to the terminal device 21 (b2 in FIG. 9). Meanwhile, the terminal device 21 activates the file browsing program 213 and displays the directory list 253 via the file browsing program 213, thus allowing the user to select a saving path directly from the directory list 253. For example, the my_family folder 2531 (see FIG. 6) is selected as the location where the processed file 251 is to be saved. Once the saving path is selected, the terminal device 21 receives a save command from the input device 22, selects the saving path in the directory list 253 that is specified by the save command, and sends a file saving path signal to the management server 23 along with the processed file 251 (b3 in FIG. 9). Upon receipt of the file saving path signal and the processed file 251, the management server 23 reads the saving path in the file saving path signal and sends the processed file 251 to a location in the file server 25 that corresponds to the saving path (b4 in FIG. 9), so as for the file server 25 to store the processed file 251. In the saving process described above, the processed file 251 is downloaded from the third-party application server 27 to the terminal device 21 and sent from the terminal device 21 to the management server 23 and subsequently to the file server 25. Thus, the third-party application server 27 is also prevented from making contact with the file server 25, and the real location of the file server 25 is effectively hidden so that private data in the file server 25 are safe from theft by those with malicious intentions.

With reference to FIG. 3, the application program 211 and the file browsing program 213 in the previous embodiment can be integrated into a web browser (e.g., using a dynamic scripting language such as JavaScript or JScript) or take the form of standalone programs. When the application program 211 and the file browsing program 213 are integrated into a web browser, and the at least one file 251 stored in the file server 25 is a picture, the management server 23 performs a “file optimization” process on the specified file 251 after downloading the specified file 251 from the file server 25, with a view to accelerating file transfer and increasing the speed at which the picture is loaded on the web browser. For instance, the management server 23 may reduce the number of pixels, the color levels, or the amount of data in the picture (i.e., picture compression). Apart from that, the management server 23 may also perform a “format conversion” process on the file 251. In the present invention, “format conversion” involves converting a file in binary format (also referred to herein as a binary file) into a file in Data URI format (also referred to herein as a Data URI file). When the terminal device 21 receives a Data URI file 251, the file browsing program 213 sends the Data URI file 251 to the application program 211, which in turn sends the Data URI file 251 to the third-party application server 27 by way of the terminal device 21. Then, the third-party application server 27 converts the Data URI file 251 into a binary file 251 so that subsequent processing steps can be performed thereon. Format conversion may also be performed in the file saving process of the present invention. To begin with, the third-party application server 27 converts the received binary file 251 into a Data URI file 251 (which has been processed) and sends the Data URI file 251 to the terminal device 21. When the terminal device 21 receives the Data URI file 251, the Data URI file 251 is sent by the application program 211 to the file browsing program 213 and then from the file browsing program 213 through the terminal device 21 to the management server 23. The management server 23 converts the Data URI file 251 into a binary file 251 and saves the binary file 251 to the file server 25.

With the Data URI conversion technique, resources which otherwise will have to be additionally downloaded can be directly incorporated into the HTML content of a webpage. Generally speaking, when a web browser loads a webpage, content written in HTML is loaded first. Whenever an <img> tag is read, an image will be downloaded according to the URL specified by the img element. For example, upon reading <img src=“images/123.png”/>, the web browser begins to download the picture “123.png” from the folder “images”. However, when the Data URI format is used, the binary code of the picture 123.png will be converted, by base64 encoding, into standard ASCII characters (e.g., iVBORw0KGgoAAA), which are directly embedded into the HTML webpage content. In that case, the web browser will read <img src=”data:image/png;base64,iVBORw0KGgoAAA> while downloading the webpage and can convert this HTML element directly into the picture content of 123.png without having to download 123.png as is conventionally required. Since the conversion between binary format and Data URI format is well know in the art, and the present invention merely incorporates this conversion technique into the steps of the disclosed method, a detailed description of the technical means of such a conversion technique is omitted herein.

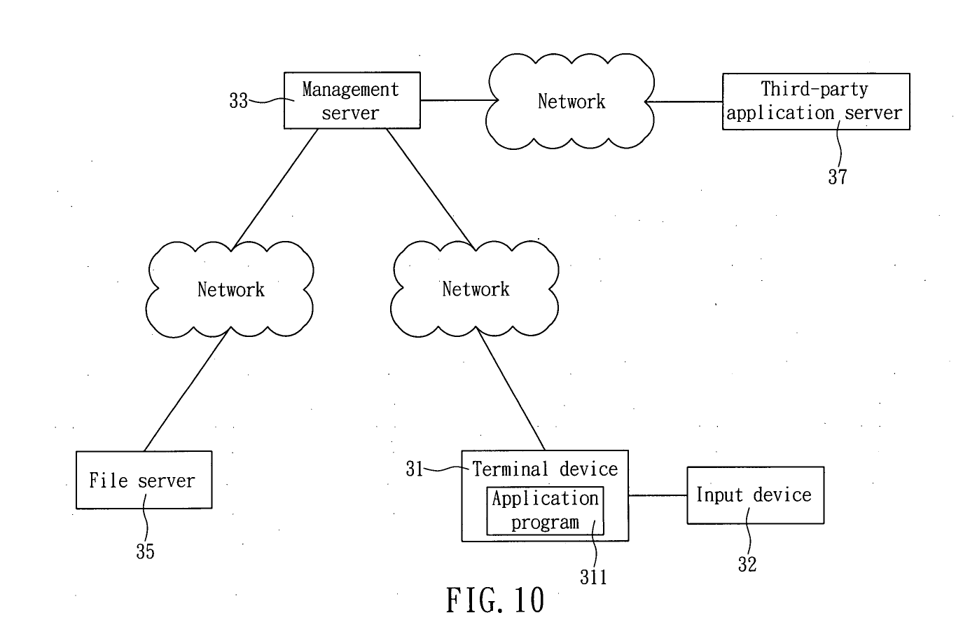

In another embodiment of the present invention as shown in FIG. 10, the third-party application server 37 is connected to the management server 33 while the terminal device 31 and the file server 35 are still connected respectively to the management server 33. When it is desired to use the services provided by the third-party application server 37, the application program 311 can be downloaded from the third-party application server 37 to the terminal device 31 via the management server 33. For example, the application toolbar 2115 shown in FIG. 4 is provided by the management server 33 and includes several application buttons 2117. A user can use the input device 32 to click on and thereby trigger one of the application buttons 2117, so as for the management server 33 to download the corresponding application program 311 from the third-party application server 37 and send the application program 311 to the terminal device 31. The application program 311, which is provided by the third-party application server 37, is coded in such a way that text spaces are reserved in advance for the web browsing button and the save button. After the management server 33 receives the application program 311 and before the application program 311 is sent to the terminal device 31, program codes written in a dynamic scripting language (e.g., JavaScript or JScript) for the web browsing button and the save button are inserted by the management server 33 into the application program 311 to ensure that the web browsing button and the save button can interact accurately with the management server 33 (e.g., to enable download of the file browsing program), thereby ensuring that the application program 311 provided by the third-party application server 37 is applicable to the method of the present invention.

Furthermore, in the present invention, the application program can send files from the terminal device to the third-party application server either directly or by way of the management server. Similarly, the third-party application server can send files to the terminal device either directly or by way of the management server. In other words, the file transfer path between the terminal device and the third-party application server can be direct or indirect (i.e., via the management server) without departing from the scope of the present invention.

In summary, when a user of the cloud computing method capable of hiding real file paths uses a third-party application server to process files stored in a file server in the local network, the third-party application server will obtain the files from the terminal device and send the processed files to the terminal device, without any connection made between the third-party application server and the file server. Hence, people with evil intentions will be unable to locate the file server through the third-party application server or through data related to the files, and any attempt to attack the file server is thus prevented. As a result, the security of the file server is effectively increased, and data in the file server are protected from theft.

The embodiments described above are only the preferred embodiments of the present invention. The terms used in describing the foregoing embodiments are illustrative only and should not be construed as restrictive of the invention. The user interfaces of the directory list, the file browsing program, the application program, the web browsing button, and the save button depicted in the drawings of the disclosed embodiments are also illustrative only, to enable the general public or a person skilled in the art to understand the substance and essence of the contents disclosed herein; the present invention is by no means limited to such graphic presentations. In practice, a person of skill in the art who has fully understood the technical features of the present invention may use other similar structures, devices, and systems to achieve the objects of the present invention. Therefore, the scope of the present invention is not limited to the above description and the accompanying drawings, and all equivalent changes that are easily conceivable by a person skilled in the art and are based on the disclosed technical features should fall within the scope of the present invention.

What is claimed is:

1. A cloud computing method capable of hiding real file paths, the cloud computing method being applicable to a network system, wherein the network system comprises a terminal device, a file server, a management server, and a third-party application server, the management server being connected respectively to the terminal device and the file server, the third-party application server being connected to the terminal device, the terminal device being installed with an application program which, when executed by the terminal device, displays a web browsing button on the terminal device, the file server storing at least one file and being configured to generate a directory list according to the at least one file, the cloud computing method comprising the steps, performed to read the at least one file, of:
receiving a first trigger command from an input device, triggering the web browsing button according to the first trigger command, and sending a browsing activation signal to the management server, by the terminal device;
receiving the browsing activation signal, reading the directory list from the file server, and sending a file browsing program and the directory list to the terminal device, by the management server;
receiving the file browsing program and the directory list and displaying the directory list via the file browsing program, by the terminal device;
receiving a file selection command from the input device, selecting a said file from the directory list according to the file selection command, and sending a file processing signal to the management server, by the terminal device, wherein the file processing signal specifies the file selected;
receiving the file processing signal, downloading from the file server the file specified by the file processing signal, and sending the specified file to the terminal device, by the management server; and
sending the specified file to the third-party application server via the application program and terminating the file browsing program, by the terminal device.

2. The cloud computing method of claim 1, wherein the application program further displays a save button on the terminal device, and the cloud computing method further comprises the steps, performed to save files, of:
receiving a second trigger command from the input device, triggering the save button according to the second trigger command, sending a file saving signal to the third-party application server, receiving a processed file from the third-party application server, activating the file browsing program, and displaying the directory list via the file browsing program, by the terminal device;
receiving a save command from the input device, selecting a saving path from the directory list according to the save command, and sending a file saving path signal and the processed file to the management server, by the terminal device, wherein the file saving path signal contains the saving path selected; and
receiving the file saving path signal and the processed file and sending the processed file to a location in the file server that corresponds to the saving path in the file saving path signal, by the management server.

3. The cloud computing method of claim 2, further comprising the step, performed by the management server after downloading the file specified by the file processing signal, of performing format conversion on the specified file, wherein the specified file, which is in binary format, is converted into Data URI format before the specified file in the Data URI format is sent to the terminal device.

4. The cloud computing method of claim 3, further comprising the step, performed by the third-party application server upon receiving the specified file, of performing format conversion on the specified file, wherein the specified file in the Data URI format is converted into the binary format.

5. The cloud computing method of claim 4, further comprising the step, performed by the third-party application server before sending the processed file to the terminal device, of performing format conversion on the processed file, wherein the processed file, which is in the binary format, is converted into the Data URI format.

6. The cloud computing method of claim 5, further comprising the step, performed by the management server upon receiving the processed file, of performing format conversion on the processed file, wherein the processed file, which is in the Data URI format, is converted into the binary format before the processed file in the binary format is sent to the file server.

7. The cloud computing method of claim 6, wherein the third-party application server is connected to the management server, and the application program is downloaded for installation by the terminal device from the third-party application server through the management server.

8. The cloud computing method of claim 7, wherein before the management server sends the application program to the terminal device, program codes written in a dynamic scripting language for the web browsing button and the save button are inserted by the management server into the application program.
